(19) United States
(12) Patent Application Publication
(10) Pub. No.: US 2023/0401547 A1
(43) Pub. Date: Dec. 14, 2023

(54) SYSTEMS AND METHODS FOR OPTIMIZED PAYMENT SELECTION AND INTELLIGENT ROUTING

(71) Applicant: JPMORGAN CHASE BANK, N.A., New York, NY (US)

(72) Inventors: Chuck LIGGETT, Asbury Park, NJ (US); Matt LOOS, Garden City, NY (US); Gary Brian WORD, Franklin, TN (US); Palka PATEL, West Hartford, CT (US); Richard RE, Manasquan, NJ (US); Keith DAWKINS, Chicago, IL (US); Tulasi MOVVA, Trumbull, CT (US); Rohini BADWAL, Edgewater, NJ (US); Amar S. KAKIRDE, Lake Hiawatha, NJ (US)

(21) Appl. No.: 17/806,247

(22) Filed: Jun. 9, 2022

(51) Int. Cl. G06Q 20/08; G06Q 20/40; G06Q 20/22; G06N 5/02

(52) U.S. Cl. CPC G06Q 20/0855; G06Q 20/405; G06N 5/027; G06N 5/022; G06Q 20/29

(57) ABSTRACT

Systems and methods for optimized payment selection and intelligent routing are disclosed. According to one embodiment, a method for optimized payment selection and intelligent routing may include: (1) receiving, by a payment selection and routing engine, obligation data for a payment from a payor; (2) identifying, by a machine learning engine, payment information from the obligation data; (3) retrieving, by the machine learning engine, client data, account data, and payment route data from the payment data; (4) retrieving, by the machine learning engine, machine learning rules for payments; (5) applying, by the machine learning engine, the machine learning rules to predict a payment route of a plurality of payment routes for the payment; and (6) routing, by the machine learning engine, the payment using the payment route.

### BACKGROUND OF THE INVENTION

### 1. Field of the Invention

Embodiments relate generally to systems and methods for optimized payment selection and intelligent routing.

### 2. Description of the Related Art

In making a payment, clients are required to indicate their preferred payment mechanism. Clients are obligated to indicate payment method. A plethora of consumer choices exist with regard to payment methods, with different payment options offering different benefits.

### SUMMARY OF THE INVENTION

Systems and methods for optimized payment selection and intelligent routing are disclosed. According to one embodiment, a method for optimized payment selection and intelligent routing may include: (1) receiving, by a payment selection and routing engine, obligation data for a payment from a payor; (2) identifying, by a machine learning engine, payment information from the obligation data; (3) retrieving, by the machine learning engine, client data, account data, and payment route data from the payment data; (4) retrieving, by the machine learning engine, machine learning rules for payments; (5) applying, by the machine learning engine, the machine learning rules to predict a payment route of a plurality of payment routes for the payment; and (6) routing, by the machine learning engine, the payment using the payment route.

In one embodiment, the obligation data comprises an identification of a payor, an identification of a payee, a payment source account, a payment destination account, a payment amount, a payment currency, and/or a payment timing.

In one embodiment, the obligation data further comprises a preferred payment routing for the payment.

In one embodiment, the method may also include coding, by the machine learning engine, the payment for risk.

In one embodiment, the machine learning engine predicts the payment route using the machine learning rules and historical data.

In one embodiment, the method may also include determining, by the machine learning engine, that a payment amount exceeds a threshold; and breaking, by the machine learning engine, the payment into a plurality of smaller payments.

According to another embodiment, a method for initiating payments, collections, and/or transfers may include: (1) receiving, by a rules orchestration program, a payment transaction from a payor to a payee; (2) retrieving, by the rules orchestration program, a plurality of available payment options; (3) retrieving, by the rules orchestration program, past transaction data for the payor and/or payee; (4) retrieving, by the rules orchestration program, rules for payment optimization; (5) identifying, by the rules orchestration program, one or more payment mechanism based on the past transaction data and/or the rules; and (6) executing, by the rules orchestration program, the payment.

In one embodiment, the past transaction data is for transactions with other financial institutions.

In one embodiment, the past transaction data is retrieved from a distributed ledger network.

In one embodiment, the rules for payment optimization identify triggers for initiating the payment including a balance, a date/time, or an event.

In one embodiment, the rules orchestration program uses a machine learning/artificial intelligence engine to identify the one or more payment mechanisms.

In one embodiment, the machine learning/artificial intelligence engine applies the past transaction data to identify the one or more payment mechanisms

Embodiments may gather payment data from either the client or for the recipient institution. In embodiments, the information may be gathered from multiple institutions and may be aggregated. Payment Aggregation may be achieved via a configurable payments warehouse that may hold a transaction for a given beneficiary and aggregating those payments.

Embodiments may net foreign exchange transactions. For example, a client may be selling currency A to buy currency B to make payments to beneficiaries in currency B. The same client may also sell currency B to buy currency A in order to make payments to beneficiaries in currency A. The foreign exchange netting engine may accrue amounts payable in both currency A and currency B. If it determines that the client is short in one of the currencies, it may cause funds to be transferred to the short position.

Embodiments may initiate and process payments in the appropriate currency. The data gathering and aggregation may be across banks and include cryptocurrencies.

Regulations require banks to be aware of critical details regarding its clients, which range from banks to large corporations that conduct wholesale business transactions globally. While basic requirements of the US Patriot Act need to be met, there may be specific in-country due diligence that may be required. Embodiments provide a payment engine module via customer/client self-service capabilities on a client data exchange platform with distributed ledgers and cross currency transfers via a Virtual Account Management (VAM). Embodiments may provide include self-service liquidity netting; a billing engine; and a reporting engine for Enterprise Resource Planners (ERPs).

Embodiments provide the ability to perform a variety of tasks that ensure data capture, aggregation, and archival of documentation are optimized.

Embodiments may provide systemic changes that result in process improvements such as: population management (e.g., bringing in all clients and scheduling across the teams in order to manage the overall book of work); bulk processing (e.g., allows for making changes across the book of work with controls inside the system versus offline tools); data integration with market utilities and internal systems onto a client data exchange platform; development of data science capabilities that optimize the data integration and data aggregation back to the end user performing the recertification on the client; delivery of local due diligence software to bring offline procedures into a system and develop a mechanism to store that data consistently for each country with special regulations; audit ready documentation (e.g., regulators require documents to be produced quickly and efficiently; each country has their own standards): narrative generation (e.g., natural language processing that enables sentences to be generated).

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for optimized payment selection and intelligent routing according to an embodiment;

FIG. 2 depicts a method for optimized payment selection and intelligent routing according to an embodiment;

FIG. 3 depicts a system for common transaction service configuration management according to an embodiment;

FIG. 4 depicts an exemplary use case for the system for common transaction service configuration management according to an embodiment;

FIG. 5 depicts an exemplary transaction service profile according to an embodiment;

FIG. 6 depicts an exemplary transaction service profile according to an embodiment;

FIG. 7 depicts an exemplary client transaction service profile according to an embodiment;

FIG. 8 depicts an exemplary transaction service configuration management work stream according to an embodiment;

FIG. 9 depicts a transaction services catalog according to an embodiment;

FIG. 10 depicts an example of transaction services according to an embodiment;

FIG. 11 depicts exemplary transaction services and enabling services according to an embodiment;

FIG. 12 depicts a transaction service manager as a configurable service that applies financial and operational controls to transactions and transaction related activity according to an embodiment;

FIG. 13 depicts an exemplary transaction service profile according to an embodiment;

FIG. 14 depicts an exemplary model for service configuration according to an embodiment;

FIG. 15 depicts an illustration of transaction services configuration data types according to an embodiment;

FIG. 16 depicts an example of transaction services initial setup and self-service use case according to an embodiment;

FIG. 17 depicts an illustration of client transaction service profiles according to an embodiment;

FIGS. 18 and 19 depict an example of client configuration according to an embodiment;

FIG. 20 depicts an example of client configuration data according to an embodiment;

FIG. 21 depicts an entity-account profile according to an embodiment;

FIG. 22 depicts a transaction services configuration use case according to an embodiment;

FIG. 23 depicts an example of PCM production payment profiles according to an embodiment;

FIG. 24 depicts an example of managing CARD according to an embodiment;

FIG. 25 depicts an exemplary use case according to an embodiment;

FIG. 26 depicts an example of viewing and using Payments CARD according to an embodiment;

FIG. 27 depicts a system for initiating payments, collections, and/or transfers according to an embodiment;

FIG. 28 depicts a method for initiating payments, collections, and/or transfers according to an embodiment;

FIG. 29 depicts an exemplary event flow for a decentralized marketplace network is provided according to an embodiment;

FIG. 30 depicts an example of a request/response service where responders help to create the service according to an embodiment;

FIG. 31 depicts an example of a routing and data enrichment service according to an embodiment;

FIG. 32 depicts an exemplary computing system for implementing aspects of the present disclosure.

### DETAILED DESCRIPTION OF PREFERRED EMBODIMENTS

Embodiments relate generally to systems and methods for optimized payment selection and intelligent routing.

In embodiments, a rules engine may inform payment methods that may be used. Artificial intelligence and machine learning may enable automated decisions based on client behavior in the past. The rules engine may optimize the best action based on, for example, a transaction value/amount, an entity type, customer profiles, payment types, netting, time of day, and rules adjudication.

In one embodiment, the rules may be based on transactions on a distributed ledger network, such as the Interbank Information Network (IIN), or the Link by J.P. Morgans^{SM} platform.

In one embodiment, the rules may be configured at, for example, a client program level, a currency level, and/or a counterparty level.

Embodiments may provide invoicing and settlement capabilities.

In one embodiment the rules engine may enable attestation, verification, and implementation.

In one embodiment, a payment obligation may be an input into the rules engine, and payments may be integrated with on-line bill payment so that the customer may optimize payments.

In one embodiment, the account selection may include the selection of an originating account, cross-currency considerations, etc.

In one embodiment, the originating account may include multiple accounts at multiple banks.

In one embodiment, a distributed ledger may be used, and any cell within the distributed ledger may contain the required information. In one embodiment, the distributed ledger may be independent of any financial institution.

In embodiments, counterparty virtual accounts may be used. One or more virtual accounts may be established for each of the client's counterparties. The client records show amounts owed to or owed by client counterparty, and may include recording at payment level, invoice level, or at an invoice line item level. Amounts paid to/paid by recorded in the virtual account and amounts may be reconciled.

Embodiments include Virtual Account Management (VAM). VAM offers clients ability to replicate their accounts with other financial institutions on a different financial institution system. Embodiments may further include the creation of sub-ledgers that hold balances, and may provide fund reporting via a system of sub-ledgers.

Embodiments may provide dynamic pricing on a case-by-case basis. For example, if an ACH payment costs less than a wire than a transaction and meets the client obligations, then ACH may be selected. In another embodiment, volume discounts may be provided for use of a lower-cost routing.

In one embodiment, real-time feedback may be provided to the machine learning engine so that the machine learning engine may implement the learning in the next transaction.

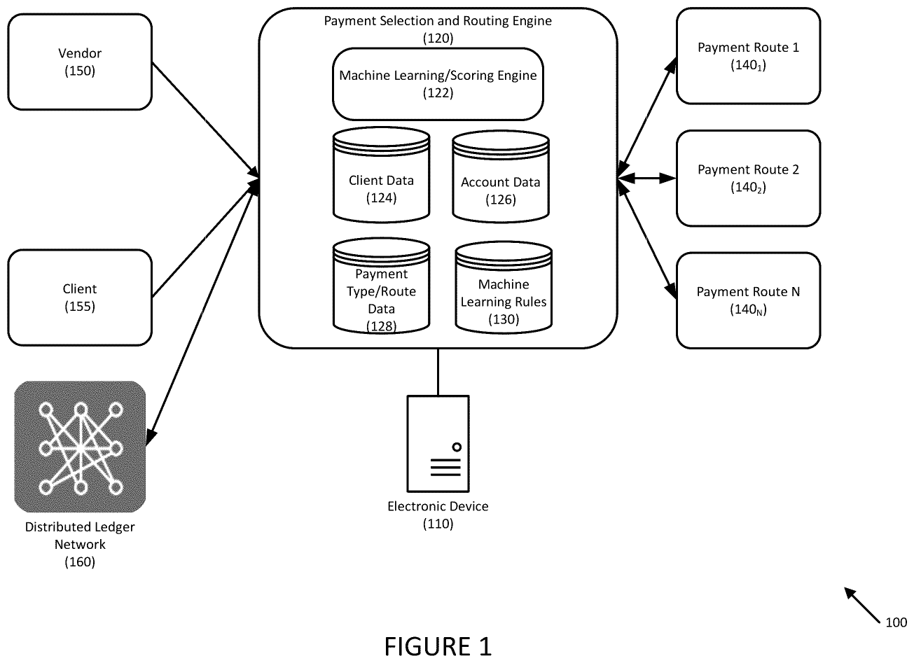

Referring to FIG. 1, a system for optimized payment selection and intelligent routing is disclosed according to one embodiment. System 100 may include electronic device 110 that may execute payment selection and routing engine 120. Payment selection and routing engine 120 may include machine learning/scoring engine 122, as well as client data 124, account data 126, payment type/route data 128, and machine learning rules 130.

Payment selection and routing engine 120 may receive obligation data from one or more source, such as vendor 150, client 155, etc. Obligation data may include payment details, such as an identification of a payor, an identification of a payee, a payment source account, a payment destination account, a payment amount, a payment currency, payment timing, preferred payment routing, etc.

Machine learning/scoring engine 122 may receive obligation data and may predict one of a plurality of payment routes (e.g., payment route 1 140₁, payment route 2 140₂, . . . payment route N 140_{N}) for routing the payment to the payee. Machine learning/scoring engine 122 may apply rules from machine learning rules 130 to predict one of the plurality of payment routes 140 for the payment. Machine learning/scoring engine 122 may also receive and apply client data 124 (e.g., payor and payee data, client profiles, on and off us accounts, preferences, etc.), account data 126 (e.g., bank, account id, currency, balances, transactions, optimal machine learning score for each transaction, etc.), payment type/route data 128 for payment routes 140 (e.g., payment type, speed of delivery, client fee, internal cost, reliability, cut-off times, beneficiary, beneficiary's bank, special arrangements with beneficiary or their bank, earning's credit allowance, variations in all of these by client and by size of transaction, etc.). Machine learning rules 130 may be updated by the machine learning engine based on past outcomes and metrics.

Machine learning/scoring engine 122 may further perform risk scoring on the received obligation, such as risk scoring based on velocity of incoming and outgoing payments, etc.

Payment selection and routing engine 120 may also interface with distributed ledger network 160, which may interface with a plurality of participant financial institutions. For example, payment selection and routing engine 120 may receive additional client data, account data, etc. from other institutions using distributed ledger network 160.

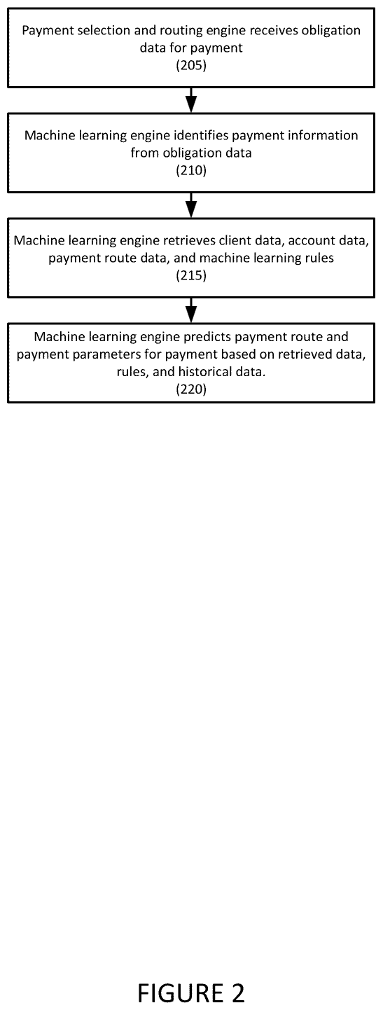

Referring to FIG. 2, a method for optimized payment selection and intelligent routing is provided according to an embodiment.

In step 205, a payment selection and routing engine may receive obligation data for a payment from a client, a vendor, etc. In one embodiment, the obligation data may include payment details, such as an identification of a payor, an identification of a payee, a payment source account, a payment destination account, a payment amount, a payment currency, payment timing, preferred payment routing, etc.

In step 210, a machine learning engine may identify payment information, such as the payor and payee, from the obligation data.

In step 215, the machine learning engine may retrieve client data, account data, and payment route data, as well as machine learning rules, to predict a payment route for the payment.

In one embodiment, the machine learning engine may code the payment for risk.

In step 220, the machine learning engine may predict one or more payment routes and payment parameters (e.g., timing, amounts, etc.) for the payment based on the retrieved data, the rules, and historical data. For example, in one embodiment, if a payment amount exceeds a threshold for a payment route, the machine learning engine may break the payment into a plurality of payments.

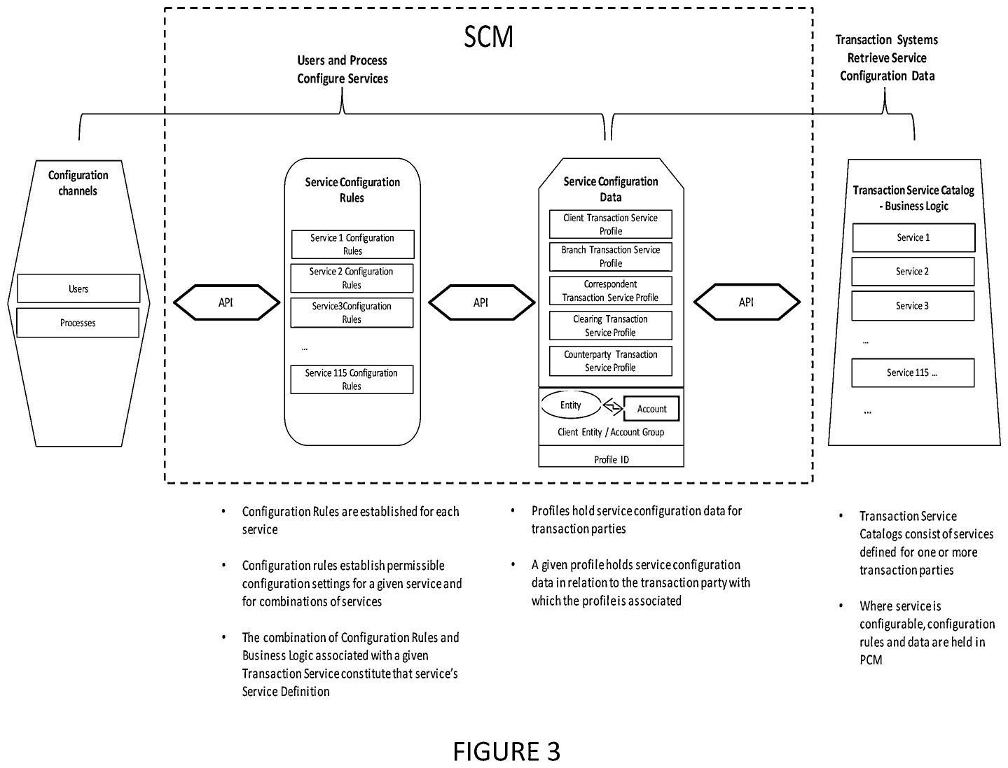

Referring to FIG. 3, an illustration of a system for common transaction service configuration management (SCM) is disclosed according to one embodiment. The system may include configuration channels (e.g., users, processes), and the service configuration management system may include service configuration rules and service configuration data. Transaction systems may retrieve service configuration data.

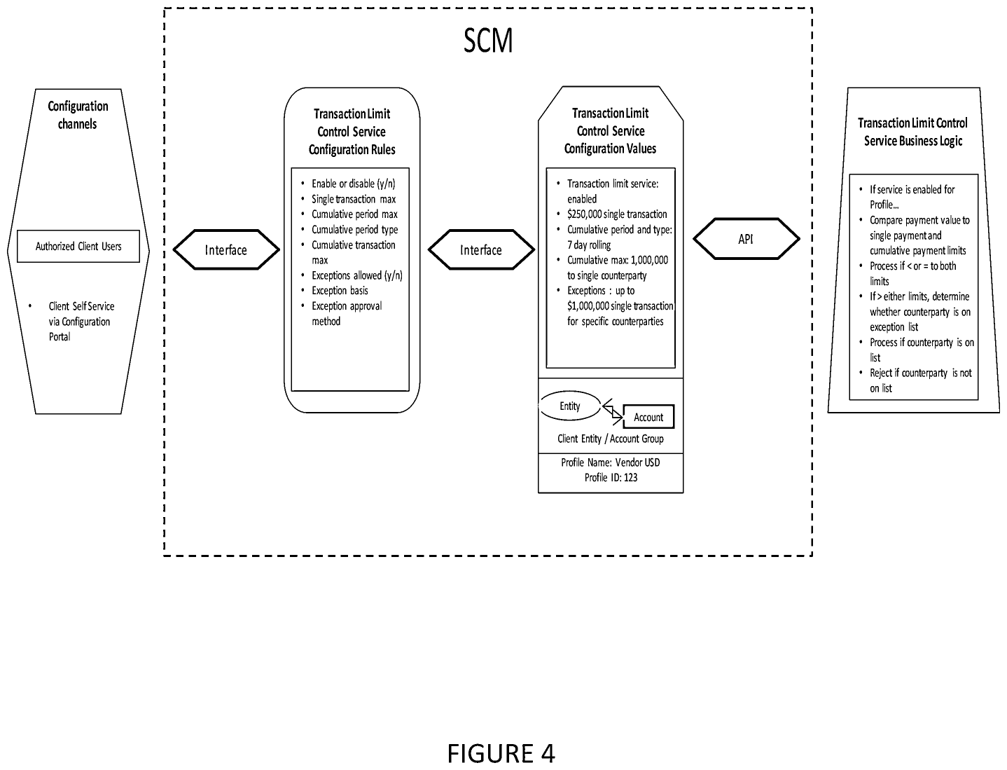

Referring to FIG. 4, an exemplary use case for the system for common transaction service configuration management is disclosed according to one embodiment. For example, the system may provide a client transaction limit control service, which is a service via which client may specify maximum single and cumulative payment values and establish the rules via which the client may manage exceptions to these limits.

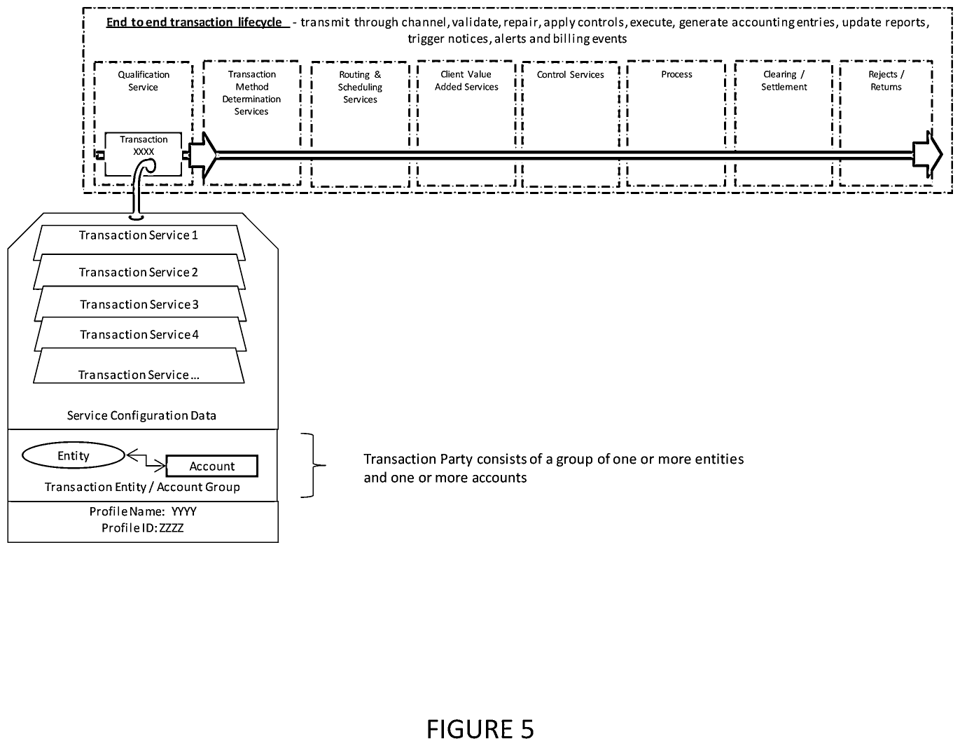

Referring to FIG. 5, an exemplary transaction service profile is disclosed according to one embodiment. According to embodiments, the transaction systems that access the configuration data may be held or indexed in SCM Transaction Service Profiles. A Transaction Service Profile may include the configuration data the Transaction Systems require to manage and process a given payment end to end in relation to the party with which the profile is associated.

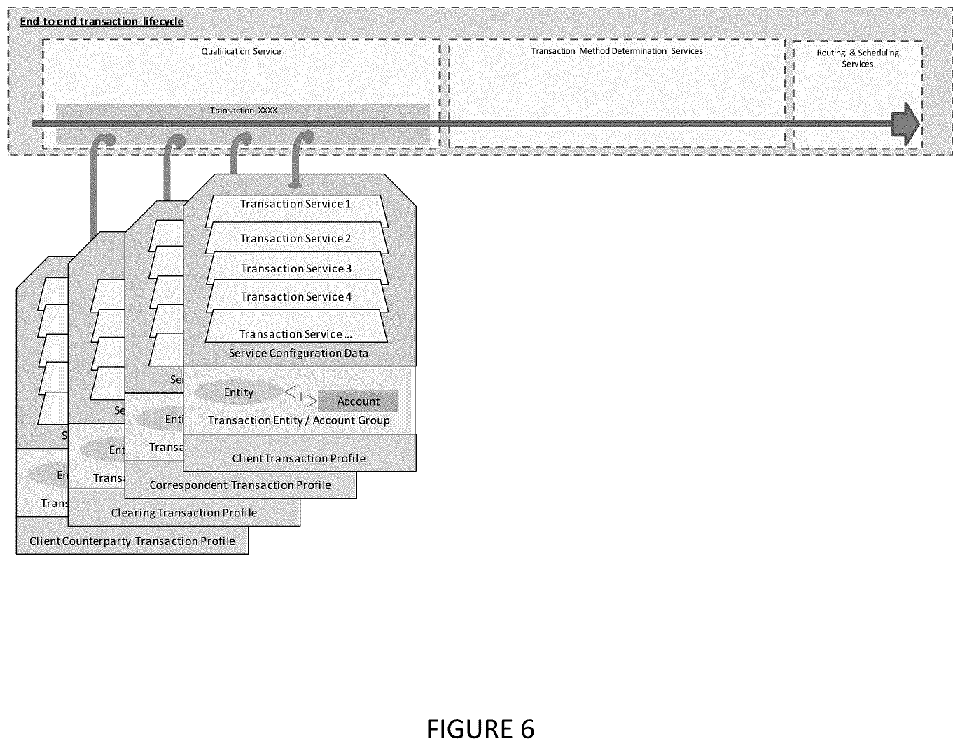

Referring to FIG. 6, an exemplary transaction service profile is disclosed according to one embodiment. For example, a payment system may require access to multiple transaction service providers to manage and process a transaction.

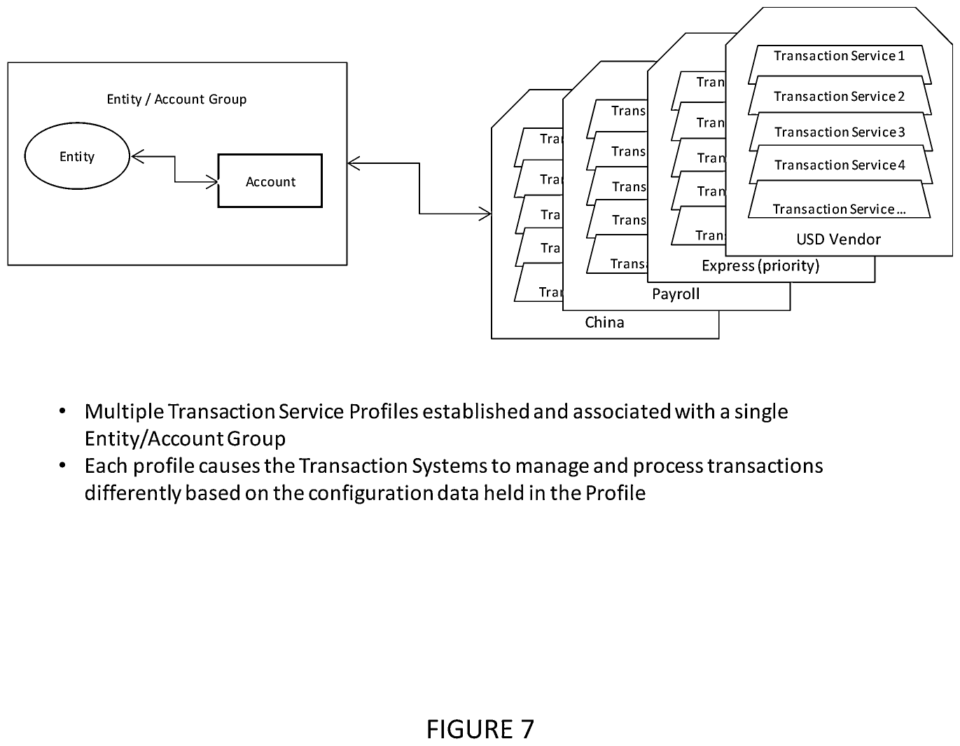

Referring to FIG. 7, an exemplary client transaction service profile is disclosed according to one embodiment. Client Transaction Profiles are those profiles that are associated with Client Entity/Account Groups (i.e., the Transaction Party is a financial institution). Client Transaction Profiles provide clients with a powerful configuration tool where any number of transaction profiles may be created and associated with a given Entity/Account Group. This allows a client to configure the transaction systems to manage and process its transaction activity based on the profile with which the transaction is associated and not strictly based on the client account.

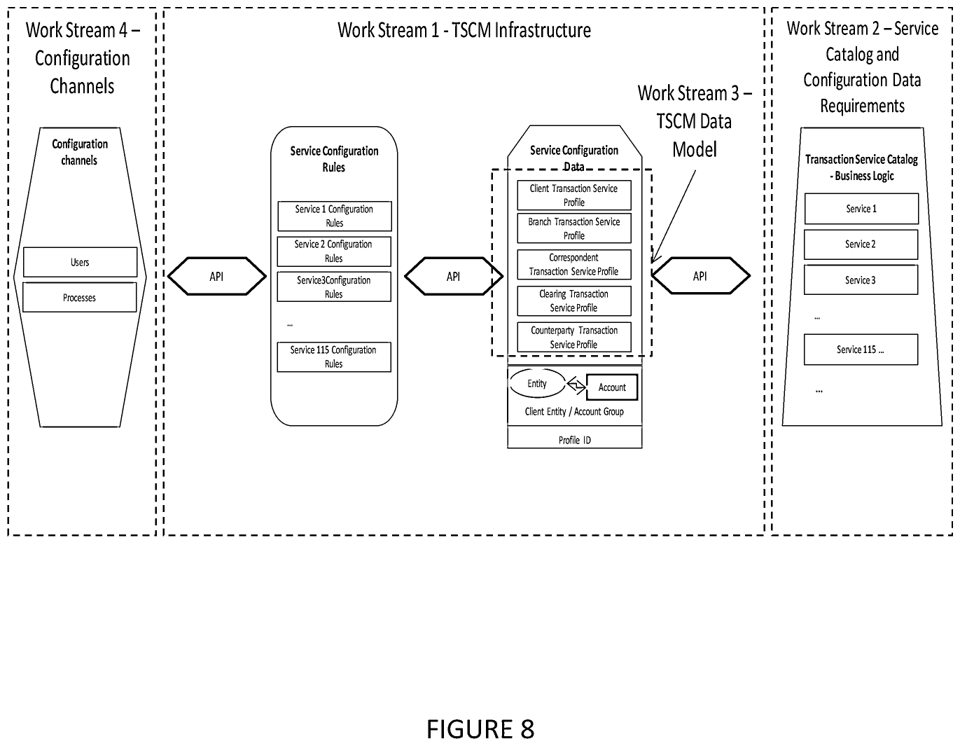

Referring to FIG. 8, an exemplary transaction service configuration management work stream is disclosed according to an embodiment. Embodiments may include five work streams: a transaction service configuration management infrastructure work stream, a service catalog and configuration data requirements work stream, a transaction service configuration management data model work stream, a channel configuration work stream, and a transaction service configuration management integration and proof of concept work stream.

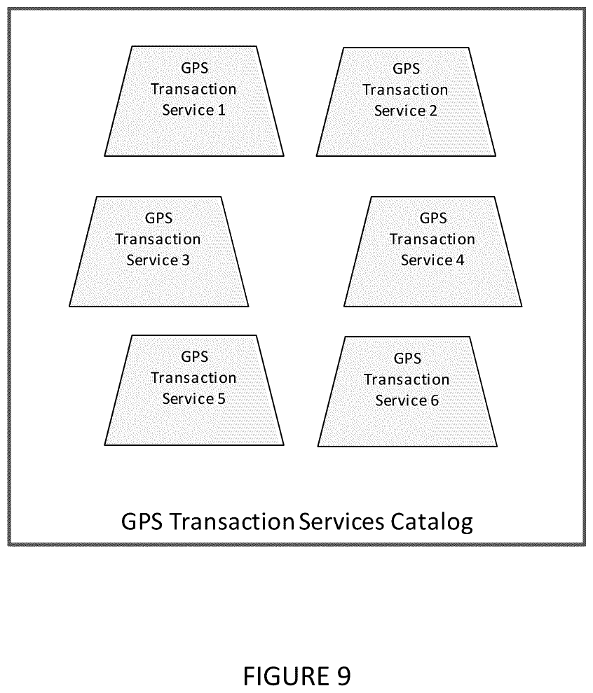

Referring to FIG. 9, a transaction services catalog is provided according to one embodiment, the transaction services catalog may include the portfolio of transaction and transaction related management services made available to treasury service clients.

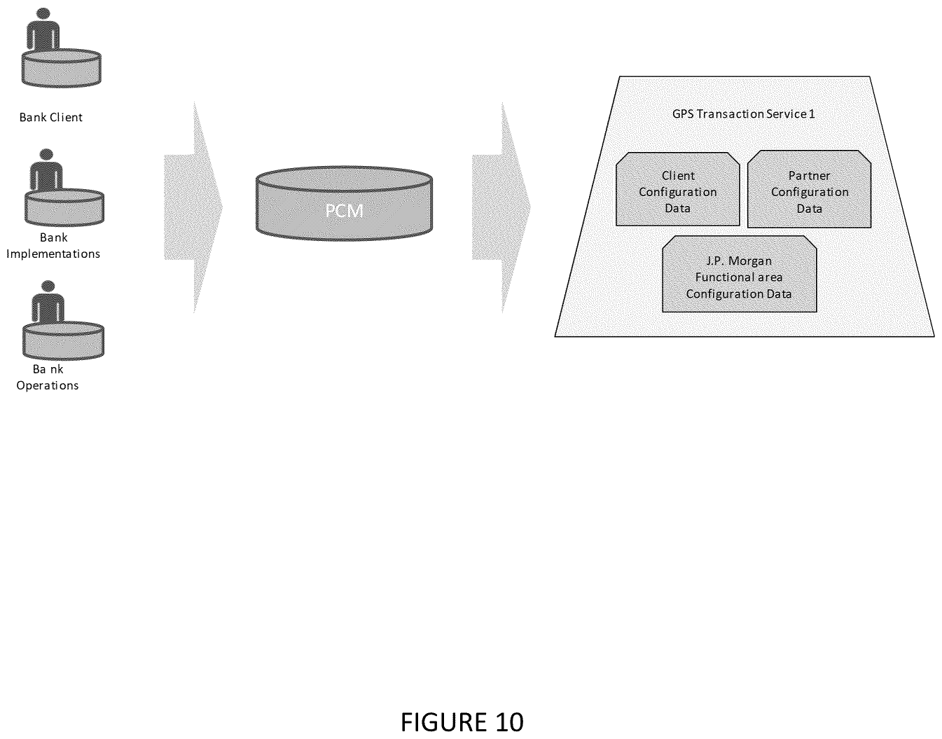

Referring to FIG. 10, transaction services may be configured by Payments Configuration Management (PCM).

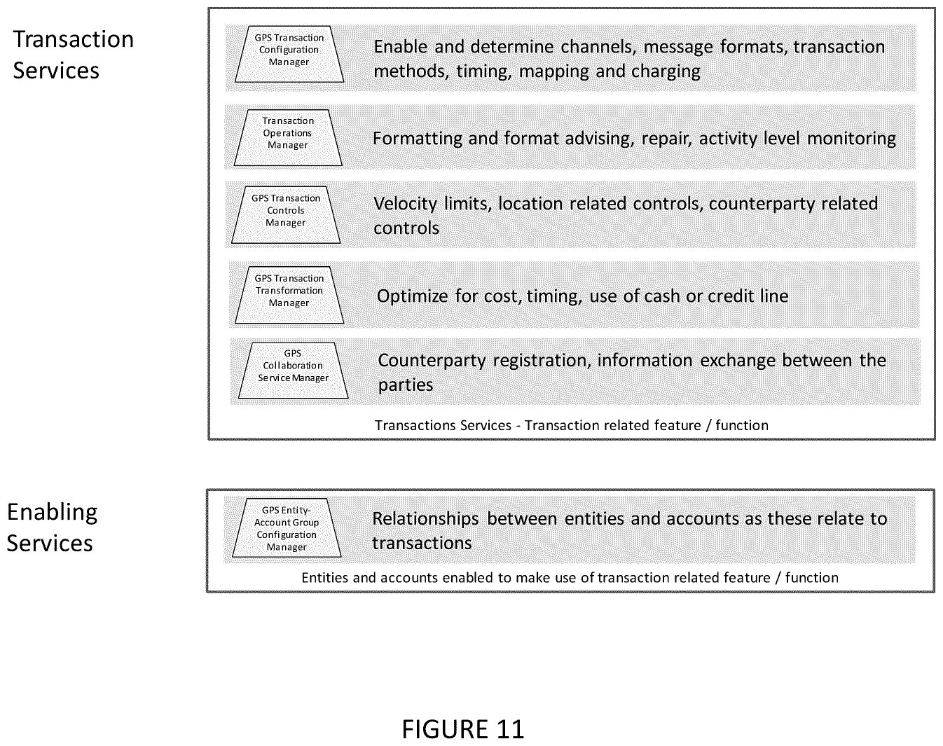

Referring to FIG. 11, exemplary transaction services and enabling services are disclosed according to embodiments.

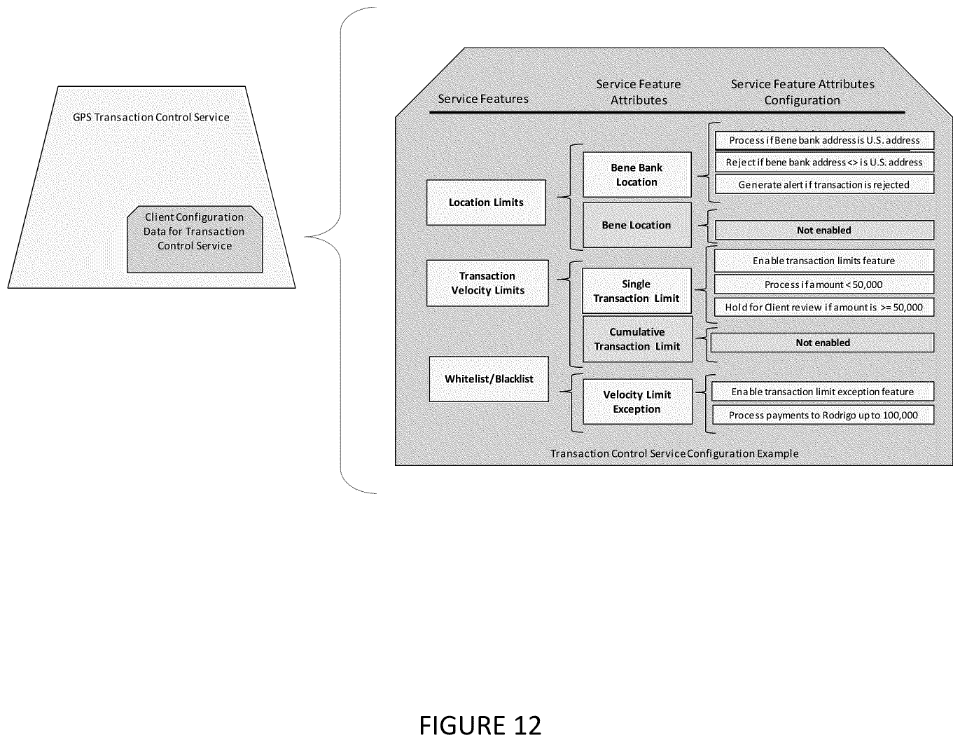

Referring to FIG. 12, the transaction service manager may be a configurable service that applies financial and operational controls to transactions and transaction related activity.

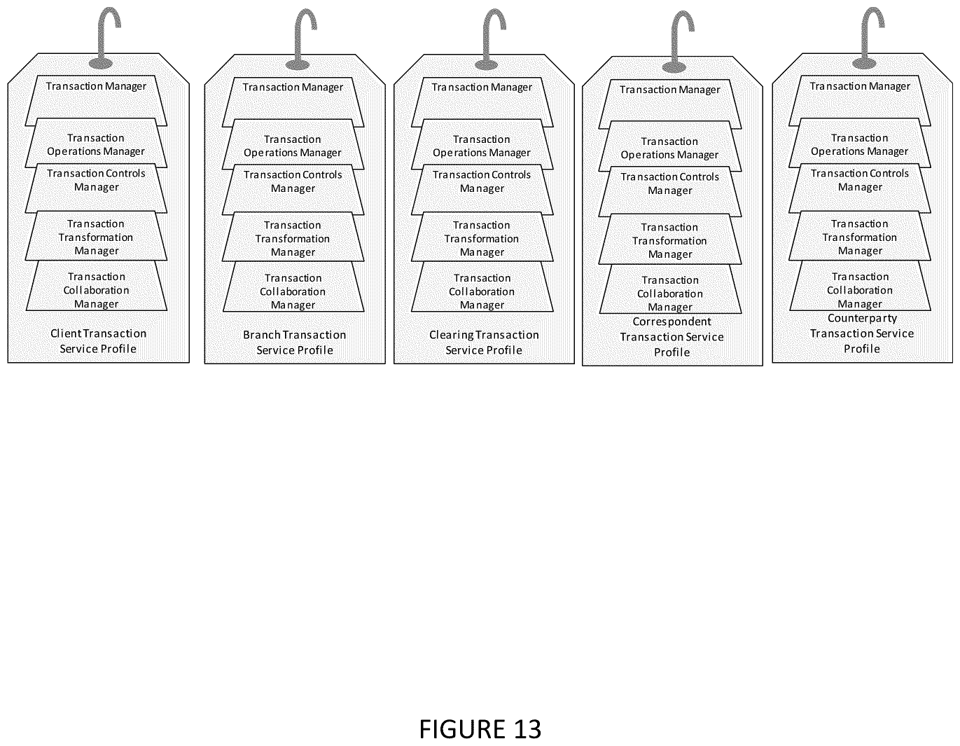

Referring to FIG. 13, an exemplary transaction service profile is disclosed according to one embodiment. For example, payment systems may access the configuration data held or indexed in SCM Transaction Service Profiles to manage and process transactions end to end. The payment services may require access to multiple Transaction Profiles to manage and process a given transaction.

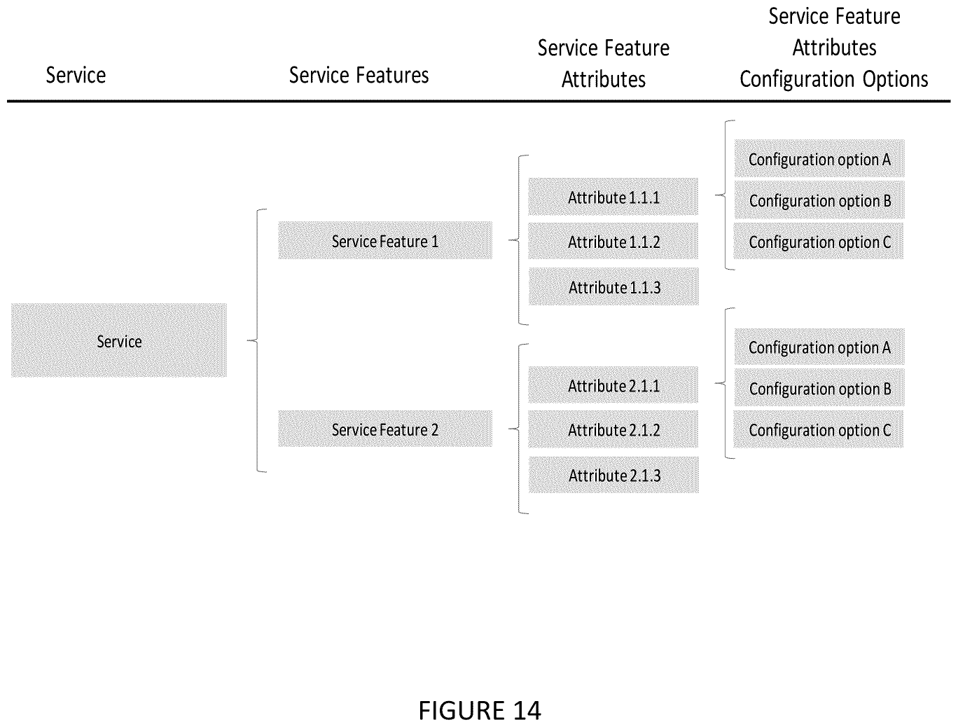

Referring to FIG. 14, an exemplary model for service configuration is provided according to an embodiment. For example, the model may: (1) Defines Service; (2) Defines Service Features that comprise a given Service; (3) Defines Service Feature Attributes for each Service Feature; (4) Identify those Feature Attributes that must be configured and rules by which values may be derived or default values assigned; and (5) Defines Configuration Options permitted for a given Attribute or combination of Attributes.

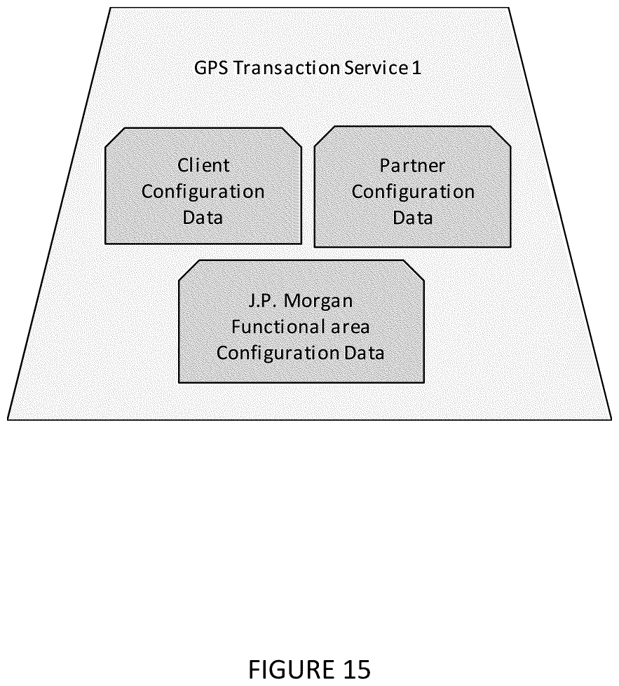

Referring to FIG. 15, an illustration of transaction services configuration data types is provided according to an embodiment. For example, data held or indexed in the payment systems may relate to clients, partners (correspondents or clearings for example), or to internal functional areas who are users of Transaction Services.

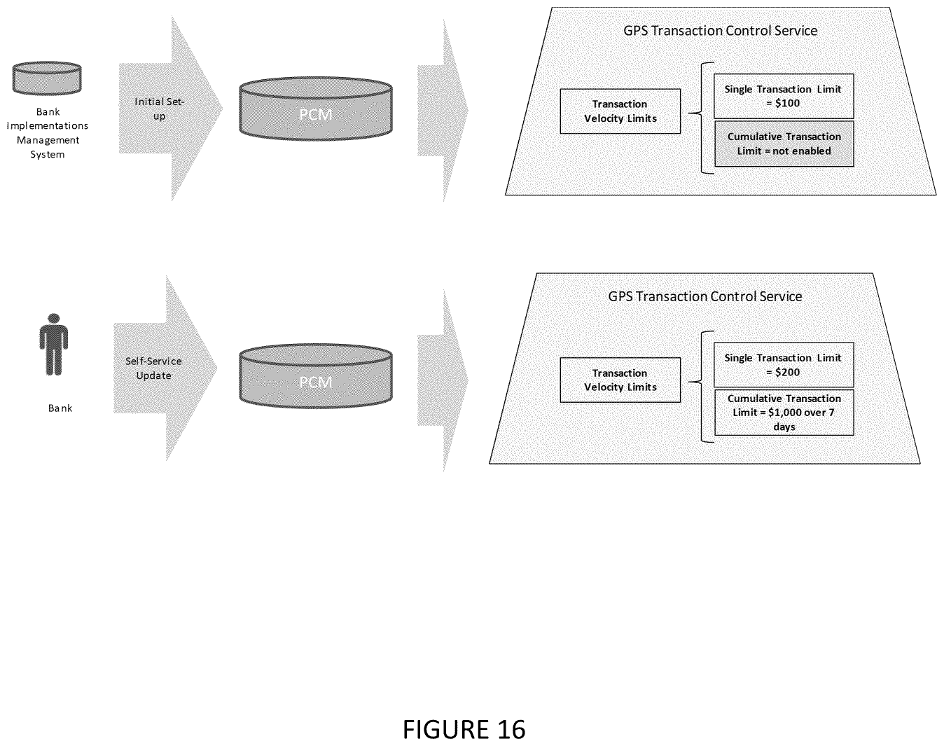

Referring to FIG. 16, an example of transaction services initial setup and self-service use case is provided according to an embodiment. Using PCM, the bank implementation system may configure transaction control service(s) using a combination of default and client-specific values via straight-through processing. The client may be subsequently updated.

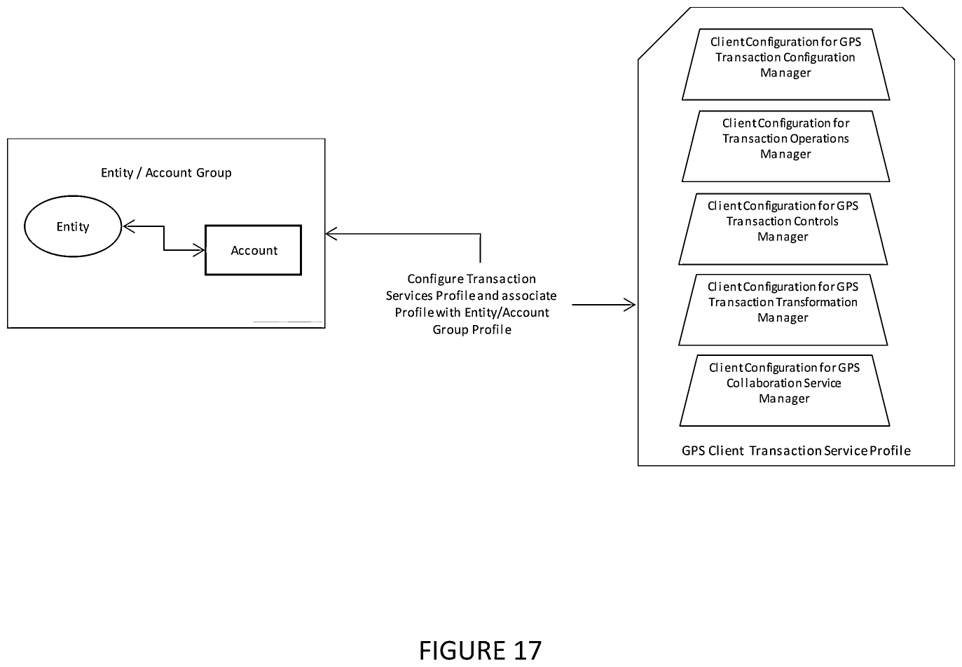

Referring to FIG. 17, an illustration of client transaction service profiles is provided according to embodiments. In embodiments, transaction services configuration data may be held in Transaction Service Profiles. Transaction Service Profiles may hold configuration data for Transaction Services even if only to indicate that a given service or service feature is not enabled for that profile. Profiles may be established and associated with entity/account group profiles.

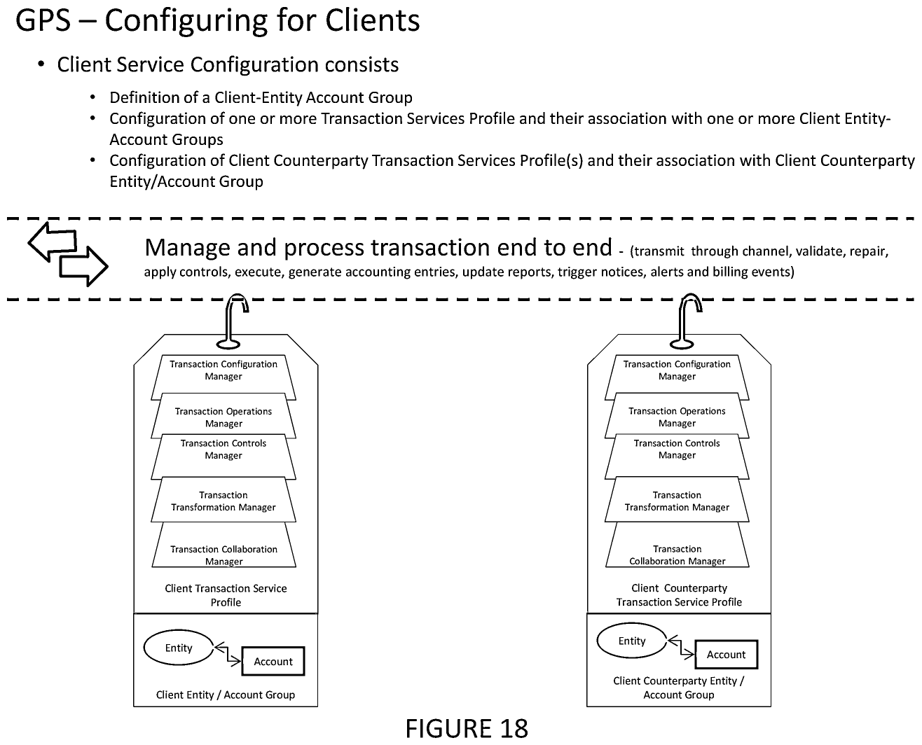

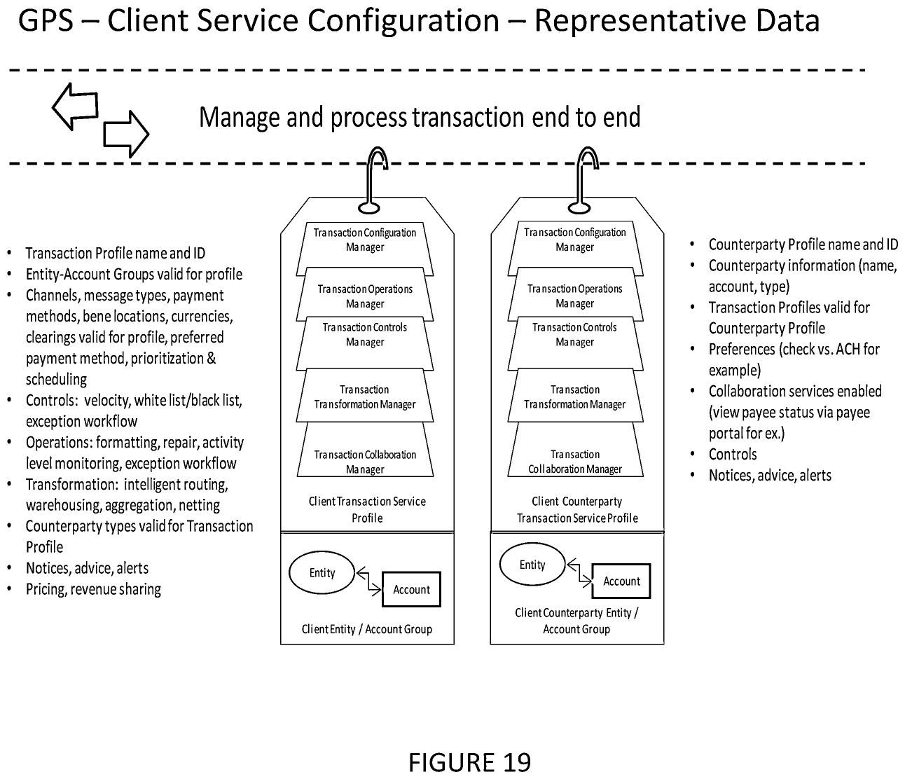

Referring to FIGS. 18-19, an example of client configuration is provided according to embodiments. A client service configuration may include: definition of a client-entity account group; configuration of one or more transaction services profile and their association with one or more client entity-account groups; and configuration of client counterparty transaction services profile(s) and their association with client counterparty entity/account group.

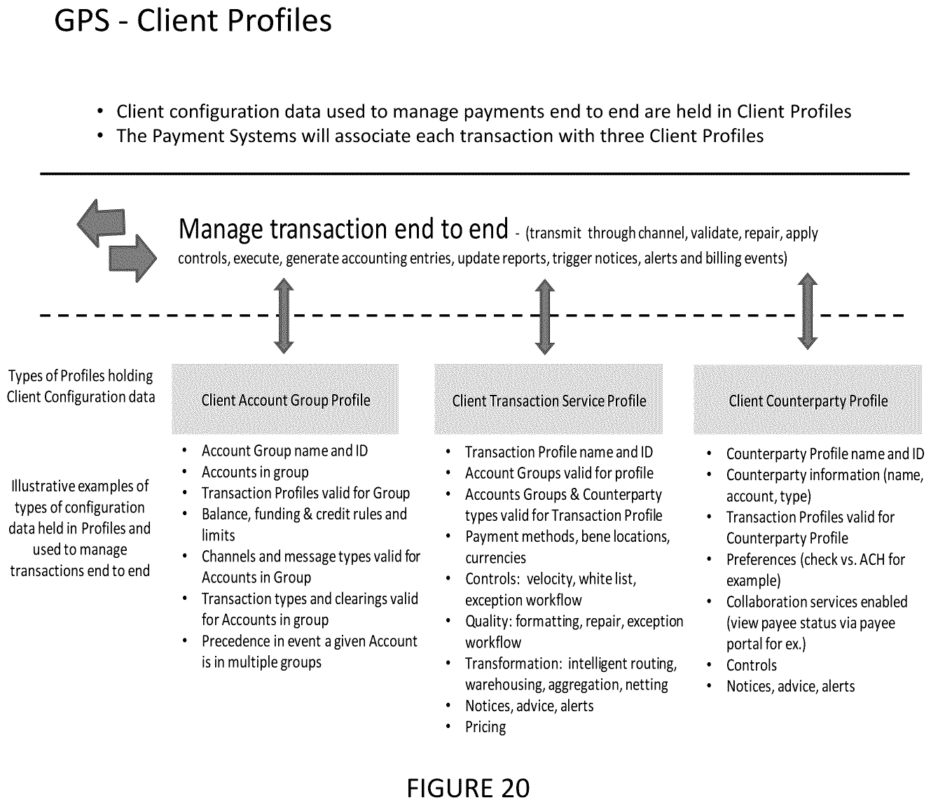

Referring to FIG. 20, client configuration data that is used to manage payment end-to-end may be held in client profiles. The payment systems may associate each transaction with a plurality of client profiles. In FIG. 20, three profiles are associated.

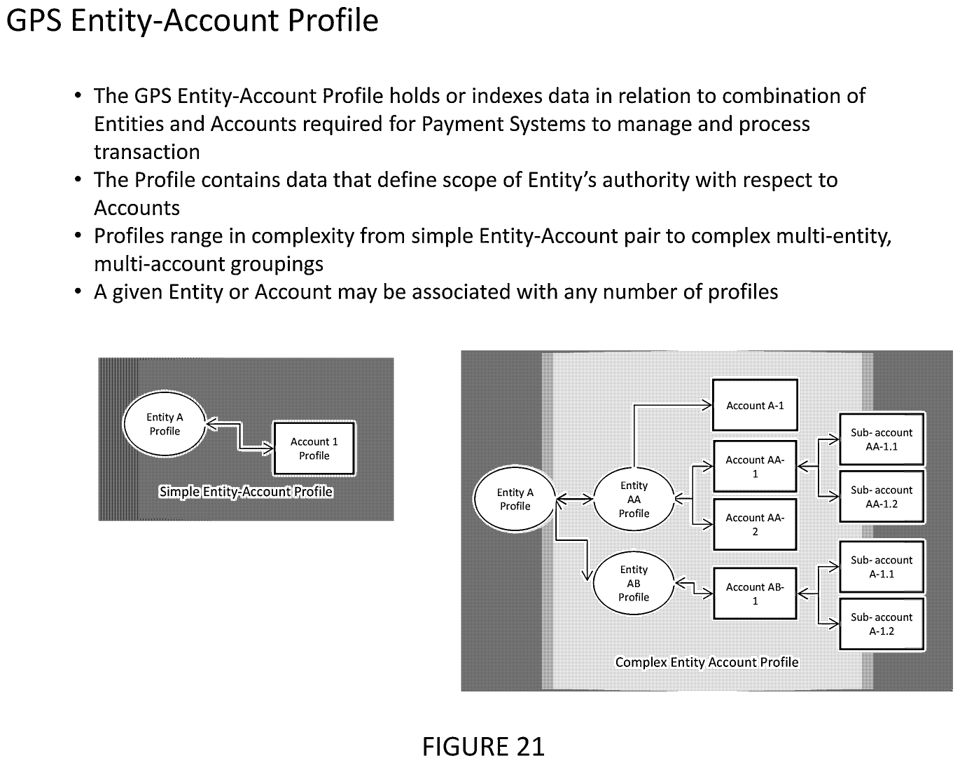

Referring to FIG. 21, an entity-account profile is disclosed according to an embodiment. The entity-account profile may hold or index data in relation to a combination of entities and accounts required for payment systems to manage and process transaction. The profile may include data that define scope of an entity's authority with respect to accounts. Profiles may range in complexity from a simple entity-account pair, to a complex, multi-entity, multi-account groupings. A given entity or account may be associated with any number of profiles.

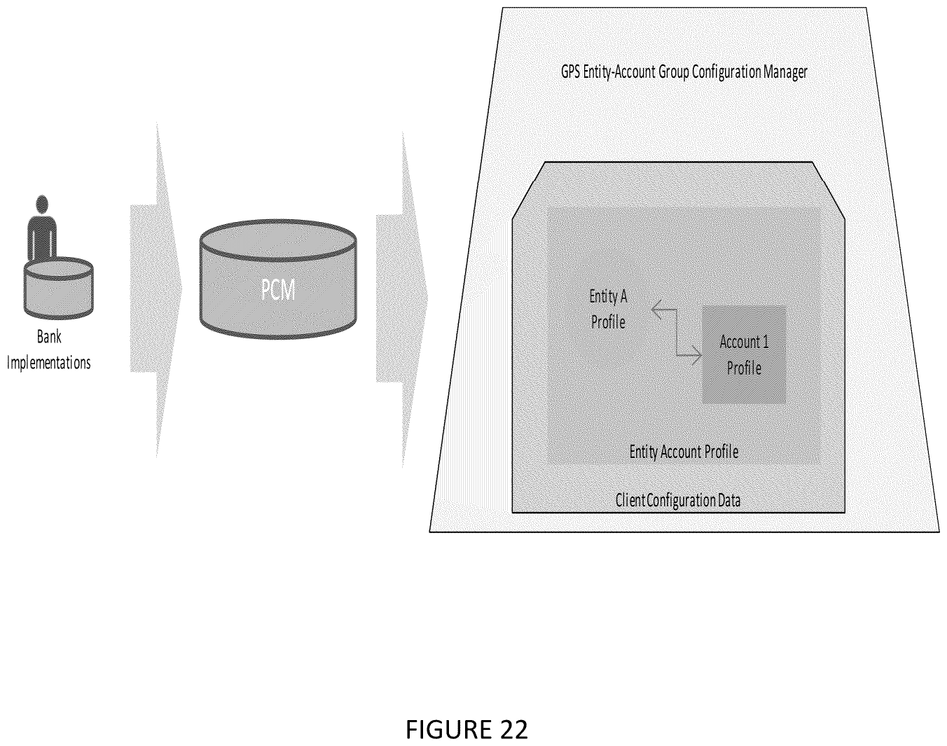

Referring to FIG. 22, a transaction services configuration use case example is provided according to one embodiment. Using PCM, the bank configures client entity and account profiles and then joins them in an entity-account profile. The entity-account profile is one of three primary configuration units in PCM, with the others being the transaction profile and the counterparty profile.

According to one embodiment, Payments Configuration and Reference Data (“Payments CARD”) may include static data that the strategic systems require to manage payments throughout the payment lifecycle. This may include: Pre-execution; Execution; and Post-execution. Payments CARD may include data held in relation to five Organization Types: Clients; Client Counterparties; Correspondents; Clearings; Branches. Examples of Payments CARD Categories may include: Profile meta data (profile name, profile ID, profile version, profile status); Rules for associating a given Production Payment Profile with a given Payment; Payment message validation and enrichment rules; Permitted Payment Types, Payment Sub Types and CSM; Permitted Payment Currencies and Payment Locations; Rules for determining CSM (e.g., intelligent routing); Payment aggregation and netting related rules; Charging and charge calculation rules; Batch payment processing rules; Rules for determining accounting method; Control, execution and posting triggers; Rules for constructing statement narratives; Rules for scheduling payment execution; Rules for assigning exception, exception reason and exception handling codes; and Control filter types and amounts.

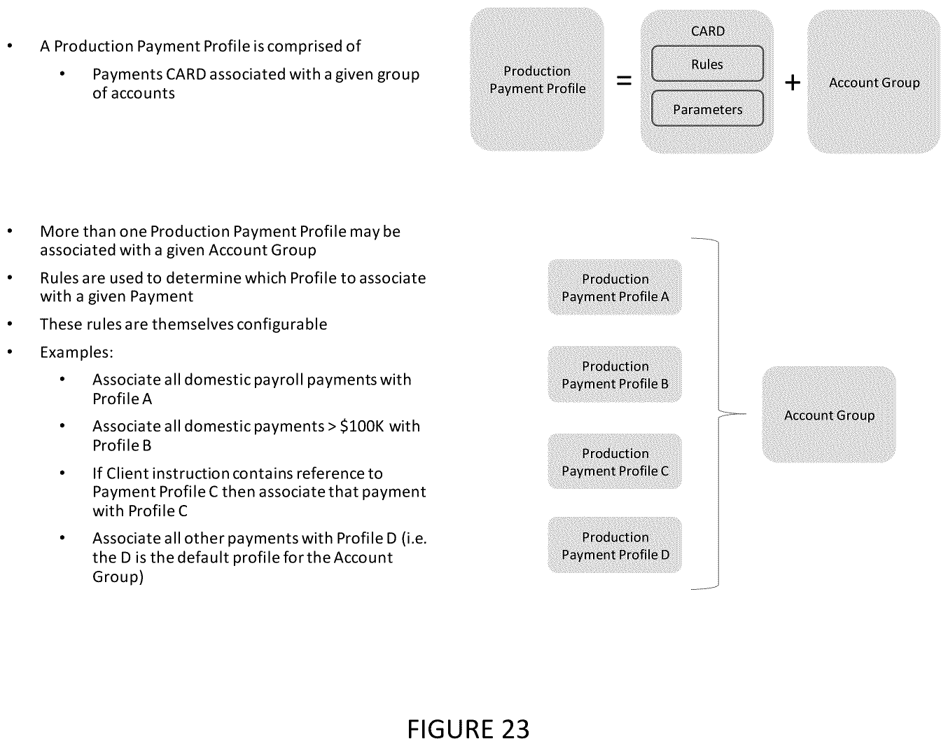

Referring to FIG. 23, an example of PCM production payment profiles is illustrated according to an embodiment.

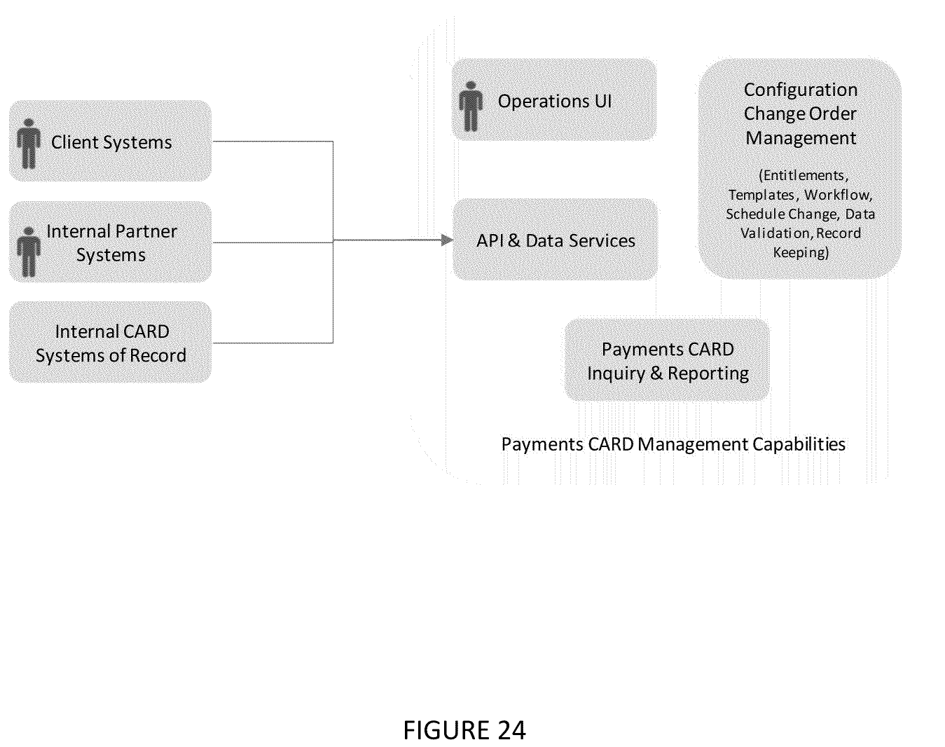

Referring to FIG. 24, an example of managing CARD is illustrated according to an embodiment. For example, Business Owners may have a singular set of capabilities via which to Manage Payments CARD. They may associate Payments CARD with a given Account or Account Group, index these CARD to an ID (i.e., Profile ID), and use the Profile ID to retrieve CARD.

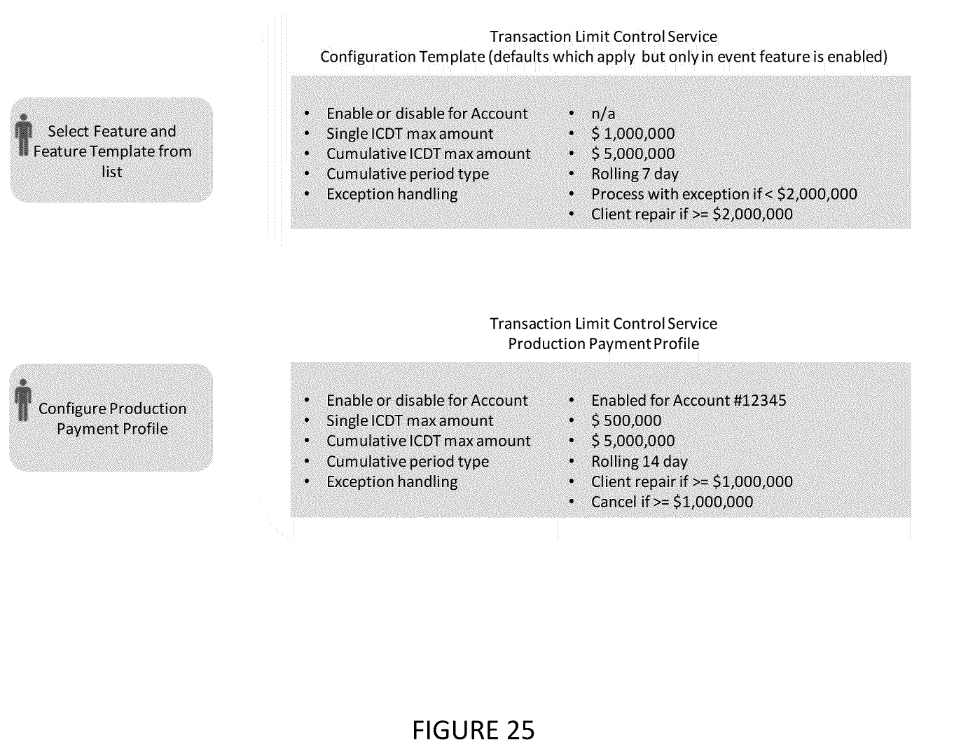

Referring to FIG. 25, an exemplary use case is provided according to an embodiment. For example, a client transaction limit control service, which is a service via which a client may specify maximum single and cumulative payment values and establish the rules via which the client may manage exceptions to these limits, is provided.

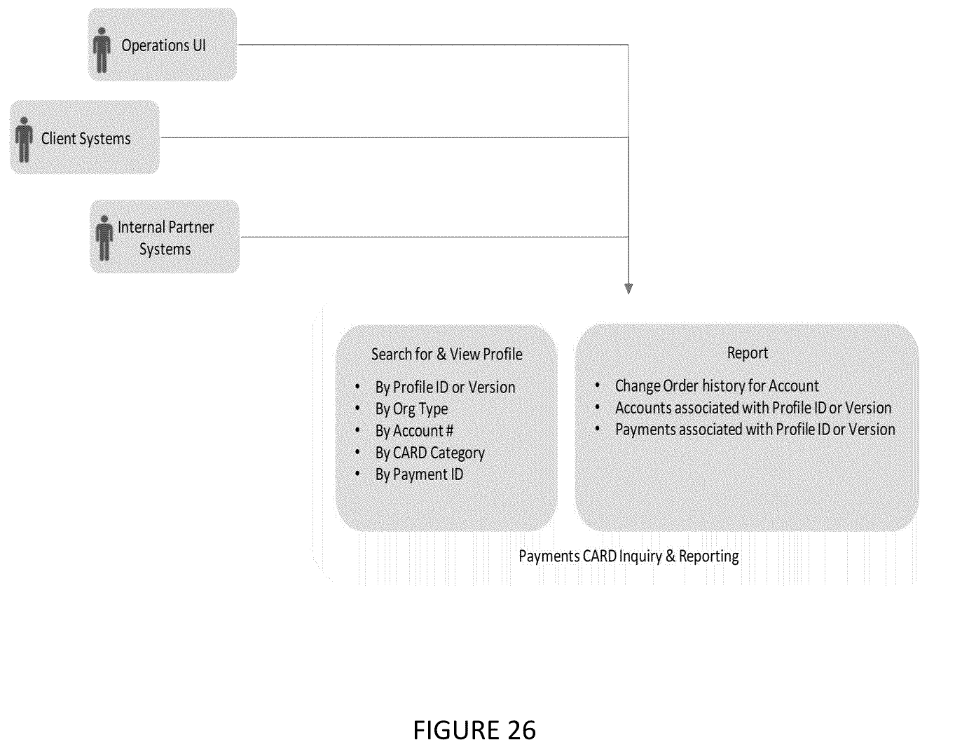

Referring to FIG. 26, an example of viewing and using Payments CARD is disclosed according to an embodiment. For example, Clients, Internal Partners and Operations are able to search and view reports via their respective user interface. They may search for Payments CARD associated with a given Account or Account Group, and/or search for Payments CARD associated with a given transaction.

Embodiments relate generally to Systemically Initiated Payments and Transfers (SIPAT) rules. The SIPAT rules may identify triggers for initiating payments, collections and/or transfers. Example of triggers may include balance, date/time, other events, combinations thereof, etc. Rules may be generated based, for example, on profile data, historical data, etc. The rules may optimize and rank payment options; in another embodiment, a consumer may review and select the payment option.

Embodiments may select one or more account as a source for payments. A self-service selection capability may provide feedback to an optimizer for this client and other similar clients.

In embodiments, multiple buckets of rules may be provided, and rule triggers may be established. In embodiments, consumers/customers may be grouped, or bucketed together, based on similarities to improve machine learning/artificial intelligence capabilities.

Embodiments may provide the ability to cross-sell products/services.

Embodiments may include a self-servicing architecture, machine learning/artificial intelligence. Self-servicing may be provided by APIs.

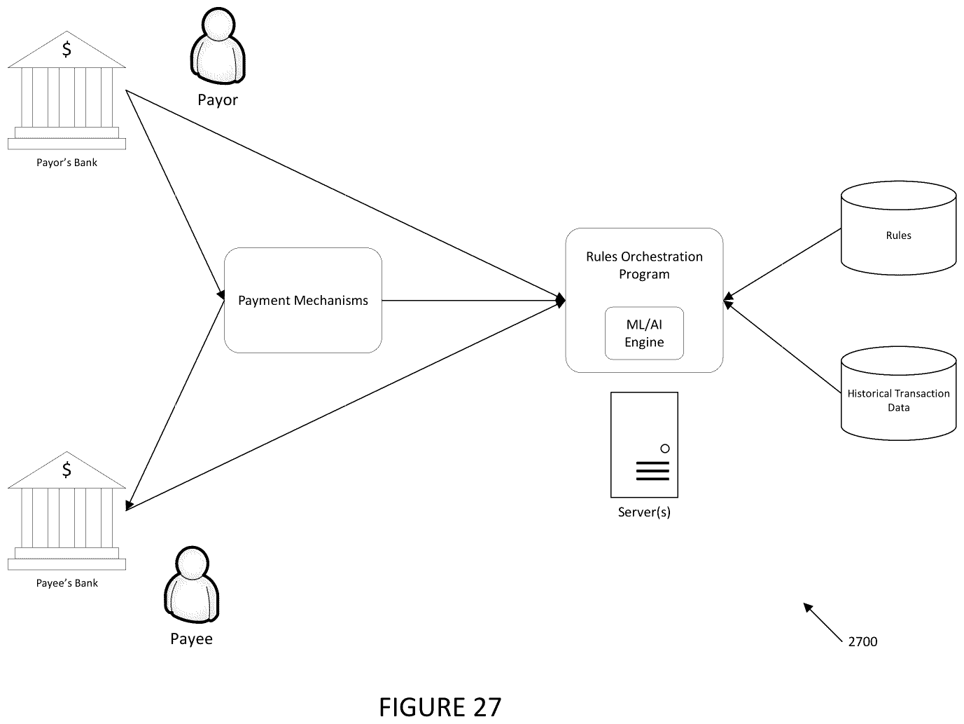

Referring to FIG. 27, a system for initiating payments, collections, and/or transfers is disclosed according to an embodiment.

System 2700 may include a payor and a payee. The payor and payee may each have an account with a respective bank, financial institution, or financial technology (FinTech) provider. Although the term “bank” is used here, this term encompasses any entity with which the payor or payee may have an account that may serve as a source or destination for a payment.

The banks may interface with a rules orchestration program that may be executed by one or more server, which may be physical servers, cloud-based servers, etc.

The rules orchestration program may receive information, such as rules and historical transaction data, from databases. Rules may include SIPAT rules.

Historical transaction data may include data for past transactions involving the payor or payee. Examples of data may include the payment mechanism(s) selected, feedback from the payor or payee, the timing of the transaction, etc.

The rules orchestration program may include ML/AI engine which may receive the rules and historical transaction data and may apply ML/AI to select one of a plurality of payment mechanisms.

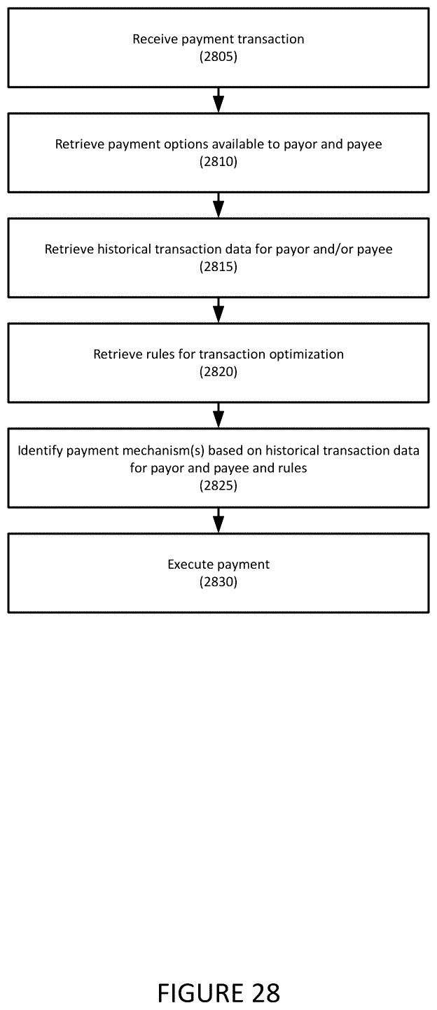

Referring to FIG. 28, a method for initiating payments, collections, and/or transfers is disclosed according to an embodiment.

In step 2805, a payment transaction from a payor to a payee may be received. The payment transaction may be received by any suitable mechanism.

In step 2810, a rules orchestration program may retrieve payment options available to the payor and the payee. Example payment mechanisms include wire, ACH, intra-bank transfer, FinTech payment (e.g., PayPal, Venmo, etc.), paper check, virtual account payment, etc.

In one embodiment, if the payee does not have a virtual account, a virtual account may be created for the payee.

In step 2815, the rules orchestration program may retrieve historical transaction data for the payor and/or payee. For example, the payment mechanism(s) used for past transactions, payment preferences, payment currency, feedback on the past transactions, etc. may be retrieved.

In one embodiment, the past transaction data may be with other financial institutions. For example, past transaction data may be retrieved from a distributed ledger network, such as the Interbank Information Network, or a similar network.

In step 2820, rules for payment optimization may be retrieved. In one embodiment, the rules may identify triggers for initiating the payment, such as a balance, a date/time, other events, combinations thereof, etc. Example rules include SIPAT rules, discussed above.

In step 2825, the rules orchestration program may identify one or more payment mechanism based on the historical transaction data and/or the rules. In one embodiment, a machine learning/artificial intelligence engine may be used to consider the historical transaction data and identify the payment mechanism(s).

In step 2830, the transaction may be executed.

In embodiments, decentralized network with multiple parties as buyers that buy products, including electronically delivered products, through that network where the products themselves are sold by sellers that may themselves buy the product from others on the same network, creates a significant challenge for providing a common pricing and payout service to all parties on the network are disclosed.

Most pricing systems are designed for a single seller with a catalog of the products they sell. The seller sets the price for each product or quantity of product. These pricing systems often support a myriad of discount models.

To provide efficient pricing service across the marketplace, a pricing service must be able to source prices and payouts from the various parties, make those prices and payouts visible to the appropriate parties, including one or more billing systems used by the sellers. One of the primary challenges in setting a price is to determine the price needed for the service to be gross profitable when accounting for direct expenses associated with purchasing the service from other parties on the network.

Embodiments may provide a pricing system that supports the setting of prices and payouts in multiple ways depending on many variables. A seller on the marketplace may work independently to create a service, work exclusively with another party, or, in the most complicated case, may work with many other parties to create the service. The pricing system may handle all prices for one-time or recurring fixed fees, transaction-based fees and value-based fees, as well as handling fee reductions as is common practices for volumes or other fee reductions. Taxes must be added to the discounted fees and may be added as obligations by the appropriate party.

For the case where the seller is buying from multiple other parties, the pricing system may accommodate multiple pricing and payout models.

In one embodiment, the seller may set a fixed, list price and a discount model for all buyers. The payouts to the other parties may be set at a list payout, subject to discounting along with the discount applied to the sales over a period of time.

In another embodiment, each of the other parties that supply the product to the seller may set their own list price for all buyers within optional bounds set by the seller with the seller adding a fixed and/or variable markup.

In another embodiment, the other parties that supply the product to the seller may set a list price that is specific to a particular buyer with the seller adding a fixed and/or variable markup.

The pricing system may account for marketplace operator fees owed by the various parties, which may include one-time fees, recurring fixed fees, fees based on transaction volume or value or on transaction revenue to the sellers.

In a decentralized network, the pricing and payout models may be available to all parties on the network that have a need to know and/or the smart contracts that execute on the decentralized network.

Key players in a decentralized marketplace network may include an operator that hosts applications provided by one or more service providers and provides secure communication channels a service can use to route data between Participant computing environments. The service providers may agree to host fees and network usage fees, may own and submit applications to the operator to provide a service on the network for use by participants, and may optionally partner with other participants to assist in creating the overall service. Participants may sign a network agreement with the operator, which may include a network membership fee.

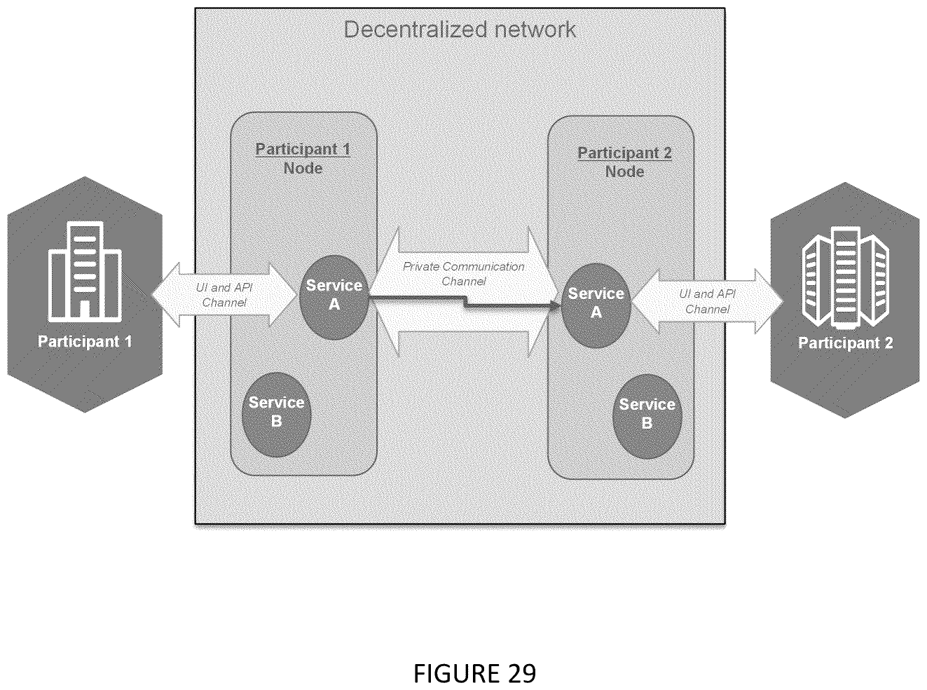

Referring to FIG. 29, an exemplary event flow for a decentralized marketplace network is provided according to an embodiment.

Each Participant has a computing environment on the decentralized network that includes their distributed ledger node. A copy of each service may be placed on the node for each member that subscribes to the service. Services may be realized as smart contracts on the nodes.

Participants may connect to their instance of a subscribed service and may provide or retrieve data (e.g., an inquiry, a response, or other data).

If the Service model includes interactions with a second participant, the service may determine (or is told by the inquirer) the other participant to communicate with, the communication is to the instance of the service running on the other participant's computing environment, and the other participant may pick up or may be sent inquiries and, depending on the model, may provide a response.

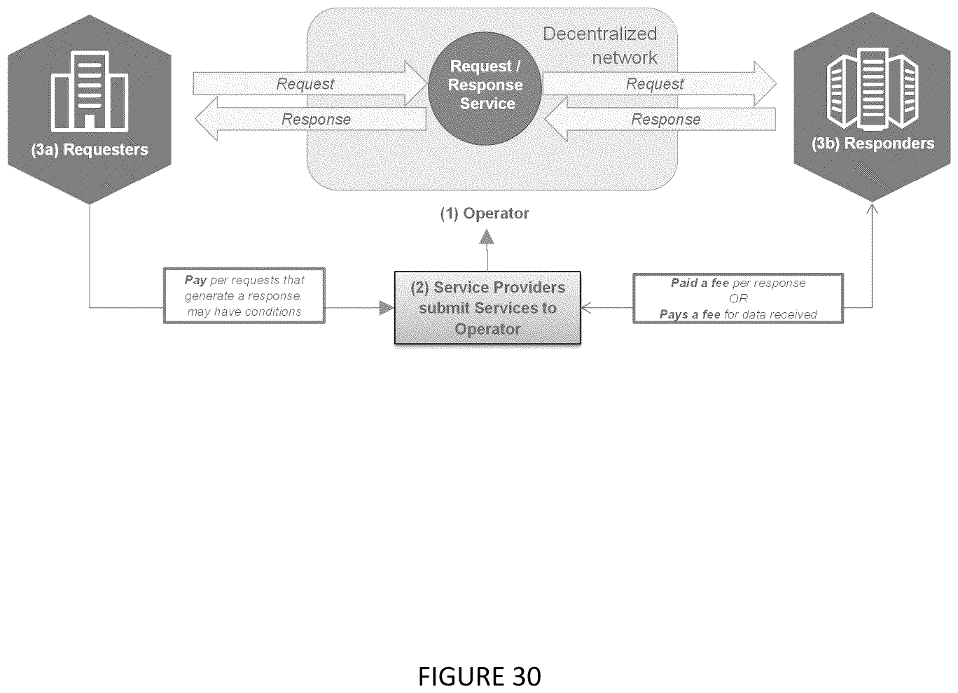

Referring to FIG. 30, an example of a request/response service where responders help to create the service is provided according to an embodiment. Parties involved in price negotiation and example fees for the request/response interaction model may include the operator and participant (e.g., may provide an enrollment fee, recurring membership fee, etc.), the operator and service provider (e.g., service/app hosting, network usage by volume, percent of revenue, etc.), the service provider and participant subscribing to service to send requests (e.g., requesters may owe a one-time set-up fee, a recurring fixed fee, such as a subscription fee, and a variable fee based on volume or value of the transactions. Volume discounts may also be applied.); the service provider and participant subscribing to service to receive requests and provide responses (e.g., depending on the type of service being offered, the responders may 1) earn a revenue share from the service provider or 2) may owe a fee for being part of the transaction, with their earnings being realized through an off-network, ancillary transaction).

Each seller may be independently responsible for tax calculations, collections, remit and reporting.

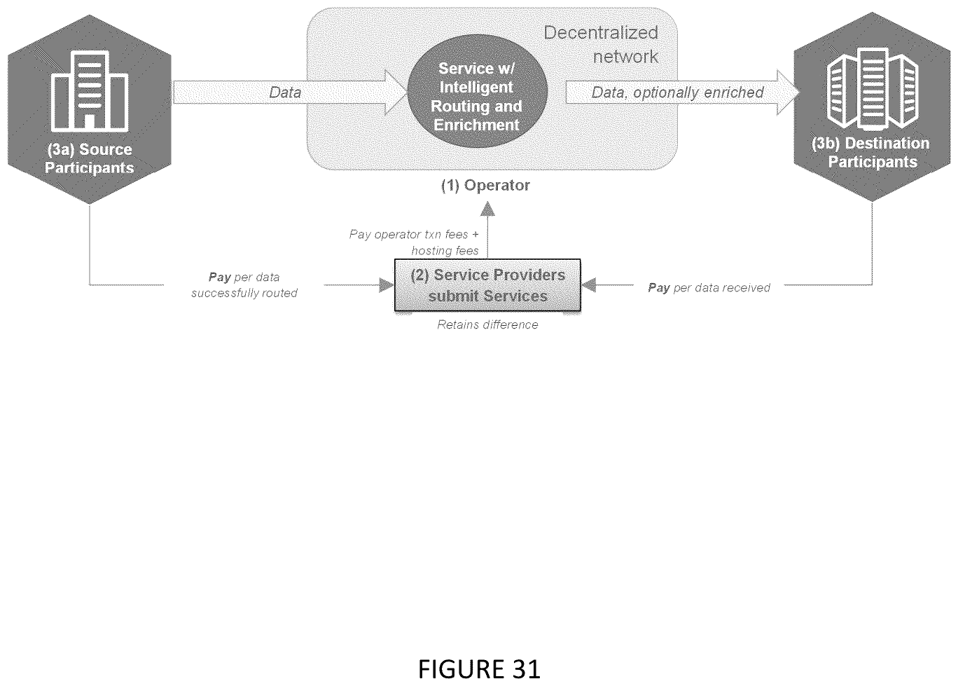

Referring to FIG. 31, an example of a routing and data enrichment service is provided according to an embodiment. Parties involved in price negotiation and example fees for the routing and enrichment interaction model may include: the operator and participant (e.g., enrollment fee, recurring membership fee, etc.), the operator and service provider (e.g., fees for hosting, network usage by volume, and percent of revenue), the service provider and participant subscribing to service to send data for routine and enrichment (e.g., source participants may owe a one-time set-up fee, a recurring fixed fee, such as a subscription fee, and a variable fee based on volume or value of the transactions. Volume discounts may also be applied); and the service provider and participant subscribing to service to receive enriched data (destination participants may owe a fee for receiving the routed, enriched data). Each seller may be independently responsible for tax calculations, collections, remit and reporting.

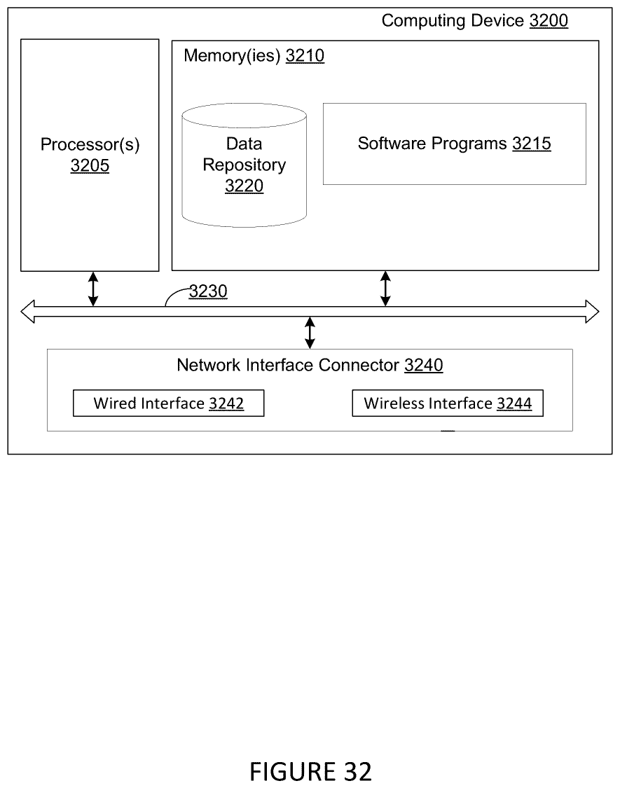

FIG. 32 depicts an exemplary computing system for implementing aspects of the present disclosure. FIG. 32 depicts exemplary computing device 3200. Computing device 3200 may represent the system components described herein, including, for example, backend electronic device 3210, user workstation 3220, user mobile electronic device 130, etc. Computing device 3200 may include processor 3205 that may be coupled to memory 3210. Memory 3210 may include volatile memory. Processor 3205 may execute computer-executable program code stored in memory 3210, such as software programs 3215. Software programs 3215 may include one or more of the logical steps disclosed herein as a programmatic instruction, which may be executed by processor 3205. Memory 3210 may also include data repository 3220, which may be nonvolatile memory for data persistence. Processor 3205 and memory 3210 may be coupled by bus 3230. Bus 3230 may also be coupled to one or more network interface connectors 3240, such as wired network interface 3242 or wireless network interface 3244. Computing device 3200 may also have user interface components, such as a screen for displaying graphical user interfaces and receiving input from the user, a mouse, a keyboard and/or other input/output components (not shown).

In another embodiment, systems and methods to provide reports, analytics and to manage on financial transactions associated with a funding agreement are disclosed. Organizations that provide funding to other organizations for specific purposes in accordance with a funding agreement currently rely primarily on the fund recipient providing evidence that the funds have been used in a manner consistent with the agreement. Audits of the fund recipients' organizations is costly, time consuming and confirms compliance with the agreement or misuse of funds on an extended timeline. Financial organizations that have details on how funds are spent do not currently have mechanisms in place for sharing bank data with a third party. Since funding recipients may each use a different financial organization, the funding organization that seek information from financial organizations will need information from multiple financial organizations. The information must be handled securely and be accessible only to authorized organizations.

Financial organizations may provide details on financial transactions associated with an account that is in receipt of the original funds, where the account can be a primary account, a sub-account or a virtual account, generally a “Funded Account.” The funding organization may include requirements for or incentives to funding applicants and include such as part of the funding application process for a funding agreement. Fund recipients may satisfy the financial organization's requirements for sharing information, such as providing authorization to the financial organization to release details associated with the funded account to the funding organization.

In one embodiment the funded account may be used by the funding recipient exclusively for a specific funding arrangement. In some embodiments, a funding agreement may include the ability for the primary funding recipient to subsequently reach other funding agreements with other funding recipients, using the original funding organizations funds as the source of funds for these so-called sub-awards. Embodiments may track the sub-awards and may provide information to the sub-award organization on the financial transactions associated with the sub-award as well as an aggregated view of all such sub-awards to the primary funding organization.

In embodiments, a funding agreement may permit the use of credit card or other commercial card accounts, with the drawn down funds being used to pay the card account when due. In such cases, embodiments may include the card transaction details as part of the financial transaction information flow and may optionally reconcile the debits on the funded account that are used to pay the card account with the credits on the card account of such payment.

In one embodiment, information on the funding transactions, sometimes referred to as “drawdown” transactions, may be provided by the funding organization to the financial organization for reconcilement with the credits to the funded account. This is useful for cases where the fund recipient may receive other funds credited to the funded account that are consistent with the intent of the funding arrangement which by way of example may be refunds or revenue from operations.

In one embodiment, the funding recipient may supplement information associated with the financial transactions, such as from a general ledger system that could be reconciled with the financial transactions associated with the funded account or manually entered for each transaction, that can provide one or more tags for the transactions on the financial account which can be used to categorize and provide an aggregated summery report of the transactions.

In one embodiment, the use of distributed ledger technology, such as with blockchains, is used to create a network that secures information, provides secure channels of communication between parties and permit multiple financial organizations as well as multiple funding organizations to all use a common distributed ledger with public and private data stores for many funding arrangements across multiple industries and for multiple purposes.

Using a distributed ledger's ability to execute code, sometimes referred to as “Smart Contracts” or “Distributed Apps (DApps)”, code that securely views all or some of the information accessible to the distributed ledger participant and create enrichment and analysis of the information, which may have been provided by multiple financial organizations, may be deployed.

Code may be added that can execute some of the terms of the funding agreement which, if included in the funding agreement and if permitted by the financial organization, may involve the initiation of financial transactions. By way of an example, if a funding agreement includes what are sometimes called a “just-in-time funding” clause for drawdowns, meaning the funds from a drawdown must be used within a specific period and not held in the funded account beyond that period of time, then a smart contract may monitor drawdowns and ensure that either the funds are utilized or returned, with a failure to use or return the funds triggering a financial transaction to debit the unused funds to the funding organization.

According to another embodiment, systems and methods to provide routing and optimization of communications among participants of multiple distributed ledgers are disclosed. With the growth of distributed ledger technology, there are now many distributed ledgers satisfying many purposes. Participants on these distributed ledgers sometimes have to participate in multiple distributed ledgers, even where the distributed ledgers may solve similar needs. Some participants have a need for communication with other participants independent of which distributed ledger the other participant has joined.

Thus, embodiments may include one or more of the following: a registry, a routing mechanism and a route optimizer. A registry of participants may include information on the ledgers on which they participate and may be managed by a party trusted by both participants. The trusted party may be one of the first two parties or could be a third party.

A routing mechanism may be provided to affect the communication once a route is determined.

A routing optimizer may be used for cases where there are multiple routes available.

Although multiple embodiments have been described, it should be recognized that these embodiments are not exclusive to each other, and that features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method for optimized payment selection and intelligent routing, comprising:
receiving, by a payment selection and routing engine, obligation data for a payment from a payor;
identifying, by a machine learning engine, payment information from the obligation data;
retrieving, by the machine learning engine, client data, account data, and payment route data from the payment data;
retrieving, by the machine learning engine, machine learning rules for payments;
applying, by the machine learning engine, the machine learning rules to predict a payment route of a plurality of payment routes for the payment; and
routing, by the machine learning engine, the payment using the payment route.

2. The method of claim 1, wherein the obligation data comprises an identification of a payor, an identification of a payee, a payment source account, a payment destination account, a payment amount, a payment currency, and/or a payment timing.

3. The method of claim 2, wherein the obligation data further comprises a preferred payment routing for the payment.

4. The method of claim 1, further comprising:
coding, by the machine learning engine, the payment for risk.

5. The method of claim 1, wherein the machine learning engine predicts the payment route using the machine learning rules and historical data.

6. The method of claim 1, further comprising:
determining, by the machine learning engine, that a payment amount exceeds a threshold; and
breaking, by the machine learning engine, the payment into a plurality of smaller payments.

7. A method for initiating payments, collections, and/or transfers, comprising:
receiving, by a rules orchestration program, a payment transaction from a payor to a payee;
retrieving, by the rules orchestration program, a plurality of available payment options;
retrieving, by the rules orchestration program, past transaction data for the payor and/or payee;
retrieving, by the rules orchestration program, rules for payment optimization;
identifying, by the rules orchestration program, one or more payment mechanism based on the past transaction data and/or the rules; and
executing, by the rules orchestration program, the payment.

8. The method of claim 7, wherein the past transaction data is for transactions with other financial institutions.

9. The method of claim 7, wherein the past transaction data is retrieved from a distributed ledger network.

10. The method of claim 7, wherein the rules for payment optimization identify triggers for initiating the payment including a balance, a date/time, or an event.

11. The method of claim 7, wherein the rules orchestration program uses a machine learning/artificial intelligence engine to identify the one or more payment mechanisms.

12. The method of claim 11, wherein the machine learning/artificial intelligence engine applies the past transaction data to identify the one or more payment mechanisms.
